(19) United States
(12) Patent Application Publication
(10) Pub. No.: US 2026/0361411 A1
(43) Pub. Date: Nov. 12, 2026

(54) OPTICAL COMMUNICATION MODULE AND METHOD

(71) Applicant: InnoLight Technology (Suzhou) Ltd., Suzhou , Jiangsu (CN)

(72) Inventors: Gang Ling, Suzhou , Jiangsu (CN); Zhe XIA, Suzhou , Jiangsu (CN); YUZHOU SUN, Suzhou , Jiangsu (CN)

(21) Appl. No.: 19/137,648

(22) PCT Filed: Oct. 27, 2023
(86) PCT No.: PCT/CN2023/127132

§ 371 Date: Jun. 11, 2025

(30) Foreign Application Priority Data
Dec. 29, 2022 (CN) 202211711564.7

(51) Int. Cl. H04B 10/40; H04B 10/079; H04B 10/572

(52) U.S. Cl. CPC H04B 10/40; H04B 10/07957; H04B 10/572

(57) ABSTRACT

The present invention relates to an optical communication module and method. According to the communication module, a transmitter laser emits signal light that is modulated by a modulation signal; a receiver laser emits local oscillator light; a coherent modulator is used to load a digital signal transmitted from a digital processor onto laser light emitted by the transmitter laser to form the signal light; a coherent receiver is used to demodulate a transmitted mixed frequency signal and then transmit the demodulated mixed frequency signal to the digital signal processor; the digital signal processor connected to the coherent modulator and the coherent receiver processes the digital signal, transmits the processed digital signal to the coherent modulator, processes the signal transmitted by the coherent receiver and then outputs the processed signal; a microprocessor is used to control the digital signal processor, a wavelength control assembly, the transmitter laser and the receiver laser; and the wavelength control assembly for controlling wavelengths of laser light outputted by the transmitter laser and the receiver laser is used. Thus, an optical communication module having low costs and a small size can be obtained.

### CROSS-REFERENCE TO RELATED PATENT APPLICATION

The present disclosure claims priority to the Chinese patent application filed with the China Patent Office on Dec. 29, 2022, with the application number 202211711564.7, and the invention name “OPTICAL COMMUNICATION MODULE AND METHOD,” the entire content of which is incorporated into the present disclosure by reference.

### FIELD OF THE DISCLOSURE

The present invention relates to the field of optical communication technology, and more particularly to an optical communication module and method.

### BACKGROUND OF THE DISCLOSURE

Because coherent technology has the advantages of high sensitivity, large communication capacity, and high bit rate, with the development and adoption of coherent module technology, high-speed modules in data centers have begun to adopt coherent technology, such as single-channel 800 G, and 4-channel 1.6 T.

Chinese patent CN202111657738.1 discloses a coherent optical module that can perform coherent optical communication. However, commonly used coherent optical modules need to use external cavity tunable laser devices, and commonly used external cavity tunable laser devices have complex structures, large volumes, and high costs. Chinese patent application CN201410059069.1 discloses a tunable laser assembly for use in a coherent optical module, in which components such as a laser, a beam splitter, an optical isolator, and a photodiode are encapsulated in a housing. Although this external cavity tunable laser has good wavelength stability and a narrow line width, it is large in size and high in cost, which is not conducive to the miniaturization and low cost of the optical module.

Therefore, a low-cost, small-volume optical communication module is needed.

### SUMMARY OF THE DISCLOSURE

Accordingly, it is necessary to provide a low-cost, small-volume optical communication module and method to address the above-mentioned issue.

In a first aspect, the present application provides an optical communication module, which includes:
a housing;
a transmitter laser located in the housing for emitting a transmitting laser;
a receiver laser located in the housing for emitting local oscillator light, in which the local oscillator light is mixed with an external optical signal to obtain a mixed frequency signal;
a digital signal processor located in the housing for processing a digital signal;
a coherent modulator located in the housing, connected to the digital signal processor, and used to load the digital signal transmitted from the digital signal processor onto the transmitting laser emitted by the transmitter laser to form signal light;
a coherent receiver, located in the housing, connected to the digital signal processor and the receiver laser, and used to demodulate and transmit the mixed frequency signal to the digital signal processor, in which the digital signal processor is further used for processing and outputting the mixed frequency signal that is demodulated;
a microprocessor, located in the housing and used to control the digital signal processor, a wavelength control assembly, the transmitter laser, and the receiver laser;
the wavelength control assembly located in the housing and used to control a wavelength of the transmitting laser and a wavelength of the local oscillator light.

In one embodiment, the transmitter laser includes a DFB laser device or a silicon photonic integrated external cavity tunable laser device.

In one embodiment, the receiver laser includes a DFB laser device or a silicon photonic integrated external cavity tunable laser device.

In one embodiment, the coherent modulator and the coherent receiver are integrated silicon photonic chips.

In one embodiment, the wavelength control assembly includes a thermistor and a wavelength adjustment member; in which the microprocessor monitors a temperature of the transmitter laser and the receiver laser through the thermistor, and adjusts the temperature of the transmitter laser and the receiver laser through the wavelength adjustment member.

In one embodiment, the wavelength adjustment member includes a TEC.

In one embodiment, the transmitter laser and the receiver laser are disposed on different ones of the TEC.

In one embodiment, the optical communication module further includes:
a mixer forming an integrated silicon photonic chip with the coherent modulator and the coherent receiver; in which the mixer is used to mix the local oscillator light emitted by the receiver laser with the external optical signal to obtain the mixed frequency signal.

In one embodiment, the transmitter laser and/or the receiver laser is a silicon photonic integrated external cavity tunable laser device, and the silicon photonic integrated external cavity tunable laser device, the mixer, the coherent modulator, and the coherent receiver form the integrated silicon photonics chip.

In a second aspect, the present application provides an optical communication method, and the method includes:
receiving external signal light;
obtaining wavelength information of the external signal light and wavelength information of local oscillator light of the receiver laser;
adjusting a local oscillator light wavelength emitted by the receiver laser according to the wavelength information of the external signal light, so that the wavelength of the local oscillator light emitted by the receiver laser tends to be consistent with a wavelength of the external signal light that is received;
mixing the wavelength of the external signal light with the wavelength of the local oscillator light emitted by the receiver laser, and demodulating the wavelength to obtain a demodulated signal.

In one embodiment, before receiving the external signal light, the method further includes:
adjusting parameters of a transmitter laser so that the transmitter laser emits signal light of a preset wavelength.

In one embodiment, before adjusting the parameters of the transmitter laser so that the transmitter laser emits the signal light of the preset wavelength, the method further includes:
adjusting parameters of the receiver laser so that the receiver laser emits local oscillator light of a preset wavelength.

In one embodiment, before adjusting the parameters of the receiver laser so that the receiver laser emits the local oscillator light of the preset wavelength, the method further includes:
formulating a relationship between parameters and wavelengths of the transmitter laser and the receiver laser into a corresponding lookup table, and storing the lookup table in a memory;
reading the lookup table to obtain the relationship between the parameters and the wavelengths of the transmitter laser and the receiver laser through the lookup table.

In one embodiment, the process of adjusting the wavelength of the local oscillator light emitted by the receiver laser according to the wavelength information of the external signal light so that the wavelength emitted by the receiver laser tends to be consistent with the wavelength of the received external signal light includes:
comparing the wavelength of the external signal light with the wavelength of the local oscillator light emitted by the receiver laser;
when the wavelength of the local oscillator light emitted by the receiving end is greater than the wavelength of the external signal light, reducing a temperature of the receiver laser;
when the wavelength of the local oscillator light emitted by the receiving end is smaller than the wavelength of the external signal light, increasing the temperature of the receiver laser.

In one embodiment, the process of receiving the external signal light includes:
receiving the external signal light that is modulated by coherent modulation.

In the above-mentioned optical communication module and method, by the design of disposing a transmitter laser, a receiver laser, a coherent modulator, a coherent receiver, a digital signal processor, a microprocessor and a wavelength control assembly in a housing; the transmitter laser emitting signal light that is modulated by a modulation signal; the receiver laser emitting local oscillator light; the coherent modulator being used to load a digital signal transmitted from the digital signal processor onto a laser emitted by the transmitter laser to form the signal light; the coherent receiver being used to demodulate and transmit the transmitted mixed frequency signal to the digital signal processor; the digital signal processor connected to the coherent modulator and the coherent receiver being used to process the digital signal, transmit the processed digital signal to the coherent modulator, and process and then output the signal transmitted by the coherent receiver; the microprocessor being used to control the digital signal processor, the wavelength control assembly, the transmitter laser and the receiver laser; and the wavelength control assembly being used to control a wavelength of the laser output by the transmitter laser and the receiver laser, a good signal demodulation effect can be achieved by using independent laser devices at a transmitter and a receiver, respectively, thereby obtaining a low-cost and small-volume optical communication module.

### BRIEF DESCRIPTION OF THE DRAWINGS

FIG. 1 is a schematic diagram of an optical communication module according to one embodiment;

FIG. 2 is a schematic diagram of the optical communication module in another embodiment;

FIG. 3 is a flowchart of the optical communication method in one embodiment;

FIG. 4 is a flowchart of the optical communication method in another embodiment.

### DETAILED DESCRIPTION OF THE EXEMPLARY EMBODIMENTS

In order for the above-mentioned objects, features and advantages of the present invention to be more obvious and easy to understand, the specific embodiments of the present invention are described in detail below in conjunction with the accompanying drawings. In the following description, many specific details are set forth to facilitate a full understanding of the present invention. However, the present invention can be implemented in many other ways different from those described herein, and those skilled in the art can provide similar improvements without violating the content of the present invention, such that the present invention is not limited by the specific embodiments disclosed below.

In the description of the present invention, it is to be understood that the terms “center,” “longitudinal,” “lateral,” “length,” “width,” “thickness,” “up,” “down,” “front,” “rear,” “left,” “right,” “vertical,” “horizontal,” “top,” “bottom,” “inside,” “outside,” “clockwise,” “counterclockwise,” “axial,” “radial,” “circumferential,” etc., indicating orientations or positional relationships based on the orientations or positional relationships shown in the accompanying drawings, are only for the convenience of describing the present invention and simplifying the description, and do not indicate or imply that the device or element referred to must have a specific orientation, and be constructed and operated in a specific orientation, and therefore should not be understood as limiting the present invention.

In addition, the terms “first” and “second” are used for descriptive purposes only and should not be understood as indicating or implying relative importance or implicitly indicating the number of the indicated technical features. Therefore, the features defined as “first” and “second” may explicitly or implicitly include at least one of the features. In the description of the present invention, “plurality” means at least two, such as two or three, unless otherwise clearly and specifically defined.

In the present invention, unless otherwise clearly specified and limited, the terms “installed,” “joined,” “connected,” “fixed” and the like should be understood in a broad sense, for example, it can be a fixed connection, a detachable connection, or an integral connection; it can be a mechanical connection or an electrical connection; it can be a direct connection or an indirect connection through an intermediate medium, it can be the internal connection of two elements or the interaction relationship between two elements, unless otherwise clearly defined. For skilled personnel in this field, the specific meanings of the above terms in the present invention can be understood according to specific circumstances.

In the present invention, unless otherwise clearly specified and limited, a first feature being “above” or “below” a second feature may indicate that the first and second features are in direct contact, or the first and second features are in indirect contact through an intermediate medium. Moreover, a first feature being “higher than,” “over” or “above” a second feature may mean that the first feature is directly above or obliquely above the second feature, or simply means that the first feature is higher in level than the second feature. A first feature being “lower than,” “under” or “below” a second feature may mean that the first feature is directly below or obliquely below the second feature, or simply means that the first feature is lower in level than the second feature.

It should be noted that when an element is referred to as being “fixed to” or “disposed on” another element, the element may be directly located on the another element or an intermediate element may be present therebetween. When the element is considered to be “connected to” the another element, it may be directly connected to the other element or an intermediate element may be simultaneously present therebetween. The terms “vertical,” “horizontal,” “upper,” “lower,” “left,” “right” and similar expressions used herein are for illustrative purposes only and are not intended to be the only way of implementation.

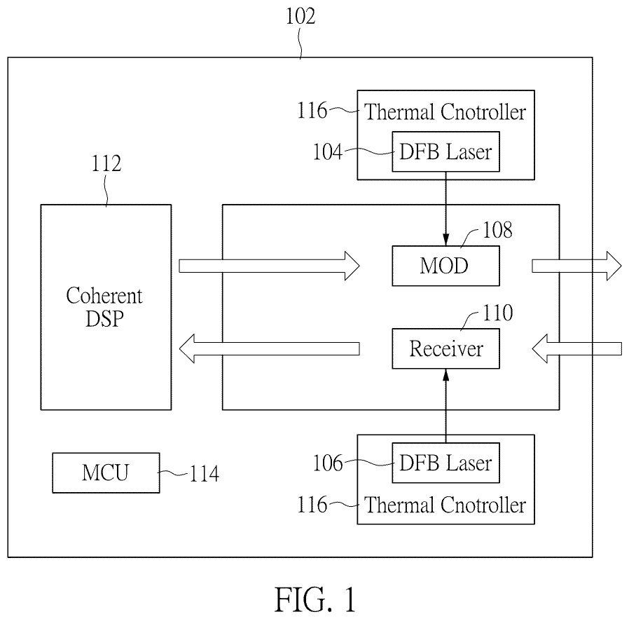

Referring to FIG. 1, FIG. 1 shows a schematic diagram of an optical communication module in one embodiment of the present invention. The optical communication module includes: a housing 102; a transmitter laser 104 located in the housing 102 for emitting a transmitting laser; a receiver laser 106 located in the housing 102 for emitting local oscillator light, in which the local oscillator light is mixed with an external optical signal to obtain a mixed frequency signal; a digital signal processor 112 located in the housing 102 for processing a digital signal; a coherent modulator 108 located in the housing 102, connected to the digital signal processor 112, and used to load the digital signal transmitted from the digital signal processor 112 onto the transmitting laser emitted by the transmitter laser 104 to form signal light; a coherent receiver 110 located in the housing 102, connected to the digital signal processor 112 and the receiver laser 106, and used to demodulate and transmit the mixed frequency signal to the digital signal processor 112; the digital signal processor 112 being further used for processing and outputting the mixed frequency signal that is demodulated; and a microprocessor 114 located in the housing 102 and used to control the digital signal processor 112, a wavelength control assembly 116, the transmitter laser 104, and the receiver laser 106; in which the wavelength control assembly 116 is located in the housing 102 and used to control the wavelength of the transmitting laser and the wavelength of the local oscillator light.

In one embodiment, the microprocessor 114 controls the operation of the digital signal processor 112, the wavelength control assembly 116, the transmitter laser 104, and the receiver laser 106. The transmitter laser 104 emits laser light, and the digital signal processor 112 processes and transmits the digital signal to the coherent modulator 108; the coherent modulator 108 loads the digital signal transmitted from the digital signal processor 112 onto the laser light emitted by the transmitter laser 104 to form signal light, and the receiver laser 106 emits and mixes laser light with the external signal light to obtain and transmit a mixed frequency signal to the coherent receiver 110; the coherent receiver 110 demodulates and transmits the transmitted mixed frequency signal to the digital signal processor 112, the digital signal processor 112 processes and outputs the transmitted signal, and the wavelength control assembly 116 controls the wavelength of the laser light output by the transmitter laser 104 and the receiver laser 106.

In the above-mentioned optical communication module and method, by the design of disposing a transmitter laser, a receiver laser, a coherent modulator, a coherent receiver, a digital signal processor, a microprocessor and a wavelength control assembly in a housing; the transmitter laser emitting signal light that is modulated by a modulation signal; the receiver laser emitting local oscillator light; the coherent modulator being used to load a digital signal transmitted from the digital signal processor onto a laser emitted by the transmitter laser to form the signal light; the coherent receiver being used to demodulate and transmit the transmitted mixed frequency signal to the digital signal processor; the digital signal processor connected to the coherent modulator and the coherent receiver being used to process the digital signal, transmit the processed digital signal to the coherent modulator, and process and then output the signal transmitted by the coherent receiver; the microprocessor being used to control the digital signal processor, the wavelength control assembly, the transmitter laser and the receiver laser; and the wavelength control assembly being used for controlling a transmitted wavelength and a local oscillator light wavelength, a low-cost and small-volume optical communication module can be obtained.

In one embodiment, the transmitter laser includes a DFB (distributed feedback) laser device or a silicon photonic integrated external cavity tunable laser device.

In one embodiment, the receiver laser includes a DFB laser device or a silicon photonic integrated external cavity tunable laser device.

By directly using a DFB laser light source without a complex frequency stabilization module (for example, the optical etalon, filter, airtight packaging box, etc. required for the tunable laser in Chinese patent application CN201410059069.1), the overall size is small, the integration is high, and the cost is low.

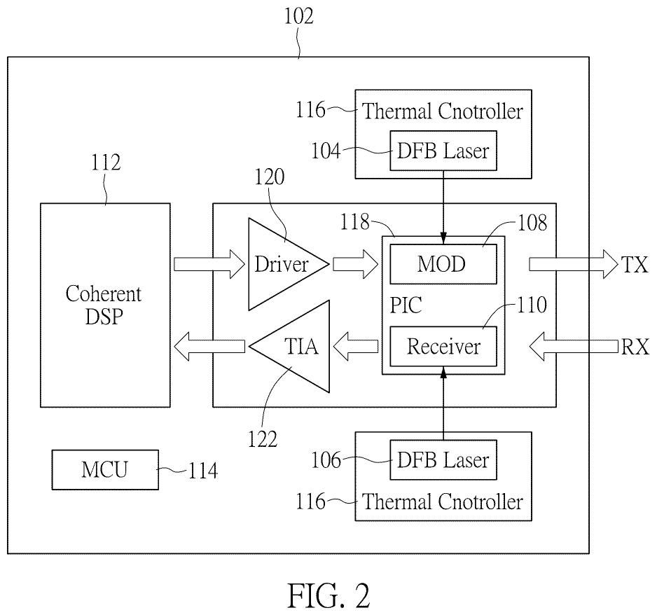

Reference is further made to FIG. 2, and FIG. 2 is a schematic modular view of an optical communication module in another embodiment of the present invention.

In one embodiment, the coherent modulator 108 and the coherent receiver 110 are each an integrated silicon photonic chip 118. It can be understood that the silicon photonic chip can be a PIC (photonics integrated circuit).

In one embodiment, the wavelength control assembly 116 includes a thermistor and a wavelength adjustment member; the microprocessor 114 monitors the temperature of the transmitter laser 104 and the receiver laser 106 through the thermistor, and adjusts the temperature of the transmitter laser 104 and the receiver laser 106 through the wavelength adjustment member.

In one embodiment, the wavelength adjustment member includes a TEC (thermo electric cooler).

In one embodiment, the transmitter laser 104 and the receiver laser 106 are disposed on different TECs.

By respectively disposing DFB laser devices at the transmitter and the receiver, and disposing the transmitter laser and the receiver laser on the wavelength adjustment member TEC, independent control of the transmitter laser and the receiver laser can be achieved.

In one embodiment, the optical communication module further includes: a mixer forming the integrated silicon photonic chip 118 with the coherent modulator 108 and the coherent receiver 110; in which the mixer is used to mix the local oscillator light emitted by the receiver laser 106 with external signal light to obtain a mixed frequency signal.

In one embodiment, the transmitter laser 108 and/or the receiver laser 106 is a silicon photonic integrated external cavity tunable laser device, and the silicon photonic integrated external cavity tunable laser device, the mixer, the coherent modulator 108, and the coherent receiver 110 form the integrated silicon photonics chip 118.

Further referring to FIG. 2, in one embodiment, a digital signal processor of an optical communication module emits an electrical signal having modulation information, and the electrical signal is modulated and amplified by the driver 120 and modulated onto the light output by the transmitter laser through the electro-optical modulation of the PIC, and then output by a TX end; the optical signal received by an RX end is demodulated by interference with the local oscillator light output by the receiver laser of the optical communication module, and the optical-to-electrical conversion is realized by a high-speed photodetector; the optical signal is converted into a voltage signal having demodulation information by a TIA (trans-impedance amplifier) 122, and the voltage signal is transmitted to the digital signal processor and demodulated by the digital signal processor to obtain an electrical signal having information.

When the optical communication module is operating, an operating temperature of the DFB laser device will affect the output wavelength of the laser device: when the operating temperature of the laser device increases, the wavelength output by the laser device increases; conversely, the wavelength output by the laser device decreases. At the same time, when a driving current of the laser device increases, the power loss of the laser device will increase, and the operating temperature will also increase, which will in turn affect the increase of the wavelength.

Therefore, in one embodiment, when the optical communication module is operating, a beat frequency signal is processed by the digital signal processor to determine the wavelength difference between the local oscillator light of the receiver laser and the transmitter laser, and the wavelength adjustment member of the receiver laser, that is, the heating amount of TEC, is further fine-tuned to maintain the wavelength consistency between the transmitter and the receiver.

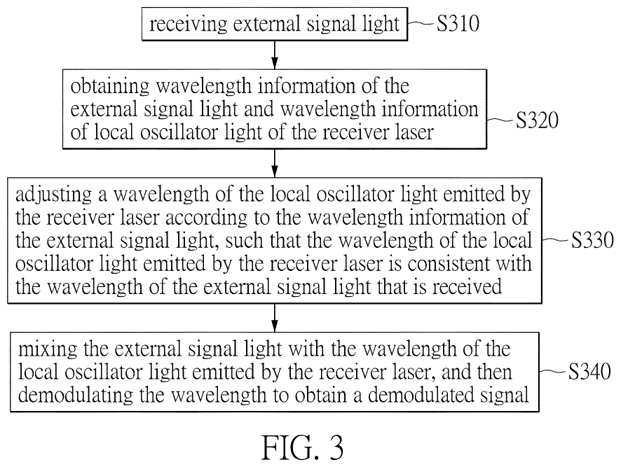

Based on the same inventive concept, one embodiment of the present application further provides an optical communication method. Referring to FIG. 3, in one embodiment, the optical communication method includes:
S310, which includes receiving external signal light.

The signal light is transmitted from the outside, and may be signal light transmitted from a transmitter of another optical communication module.
S320 includes obtaining wavelength information of the external signal light and wavelength information of local oscillator light of the receiver laser.
S330 includes adjusting a local oscillator light wavelength emitted by the receiver laser according to the wavelength information of the external signal light, such that the wavelength of the local oscillator light emitted by the receiver laser is consistent with the wavelength of the external signal light that is received.
S340 includes mixing the external signal light with the wavelength of the local oscillator light emitted by the receiver laser, and then demodulating the wavelength to obtain a demodulated signal.

The abovementioned optical communication method can obtain the wavelength information of the external signal light and the wavelength information of the local oscillator light of the receiver laser after receiving the external signal light, and adjust the wavelength of the local oscillator light emitted by the receiver laser according to the wavelength information of the received external signal light, so as to keep the wavelength of the local oscillator light emitted by the receiver laser consistent with the wavelength of the received external signal light, and finally mix the external signal light with the wavelength of the local oscillator light emitted by the receiver laser, and perform demodulation to obtain a demodulated signal. Through this optical communication method, different laser devices can be disposed at the transmitter and the receiver, so as to reduce the volume of the optical communication module, and by keeping the wavelength output by the receiver laser consistent with the wavelength of the received signal light, the subsequent signal extraction becomes more accurate.

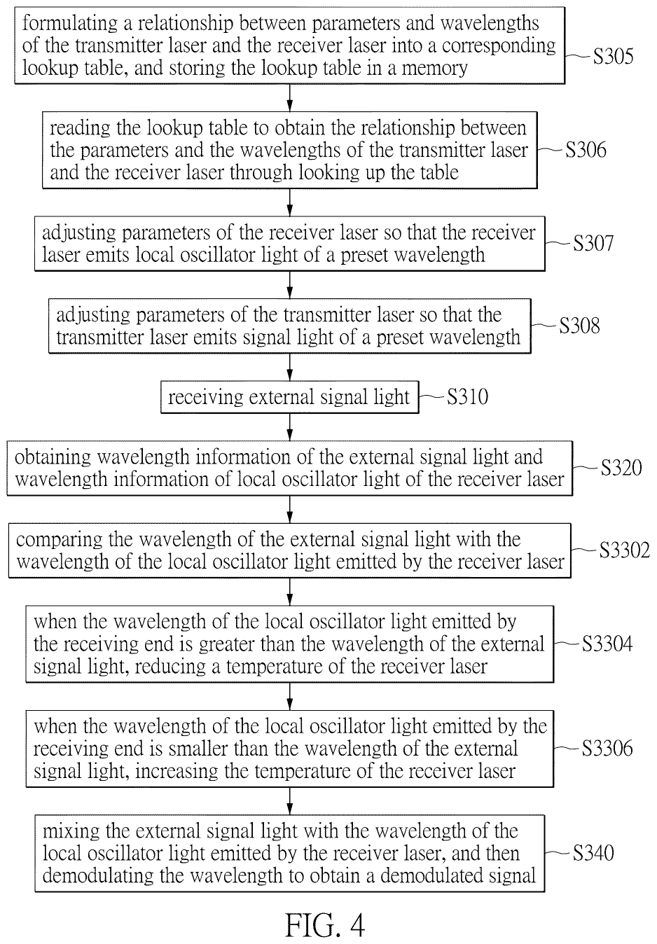

Referring to FIG. 4, in one embodiment, before receiving the signal light in S310, the optical communication method further includes:
S305, which includes formulating a relationship between parameters and wavelengths of the transmitter laser and the receiver laser into a corresponding lookup table, and storing the lookup table in a memory.

Specifically, the operating current of the transmitter laser is fixed, and the wavelength is adjusted by adjusting the wavelength adjustment member of the transmitter laser to control the temperature of the transmitter laser. Optionally, the wavelength adjustment member can be TEC. Optionally, the parameter of the transmitter laser is set to the temperature value of the transmitter laser. M transmitter laser temperature monitoring points are set: TX Thermal Monitor_1, TX Thermal Monitor_2, . . . , TX Thermal Monitor_i, . . . , TX Thermal Monitor_M, where I≤M. Optionally, the temperature values of the M transmitter laser temperature monitoring points can be obtained through a thermistor.

Specifically, when the transmitter laser temperature monitoring point is set to TX Thermal Monitor_1, the obtained wavelength of the transmitter laser is TX WaveLen_1; when the transmitter laser temperature monitoring point is set to TX Thermal Monitor_2, the obtained wavelength of the transmitter laser is TX WaveLen_2. Accordingly, when the transmitter laser temperature monitoring point is set to TX Thermal Monitor_M, the obtained wavelength of the transmitter laser is TX WaveLen_M. Thus, the wavelengths of the transmitter laser under different transmitter laser temperature monitoring points are scanned, and then the transmitter laser lookup table is formulated.

In certain implementations, the abovementioned transmitter laser lookup table may be as shown in Table 1.

TABLE 1

| Transmitter laser tempera- | Wavelength of the |
|---|---|
| ture monitoring point | transmitter laser |
| TX Thermal Monitor_1 | TX WaveLen_1 |
| TX Thermal Monitor_2 | TX WaveLen_2 |
| TX Thermal Monitor_3 | TX WaveLen_3 |
| . . . | . . . |
| TX Thermal Monitor_i | TX WaveLen_i |
| . . . | . . . |
| TX Thermal Monitor_M | TX WaveLen_M |

Similarly, a relationship between the parameters and wavelengths of the receiver laser can be obtained, so as to formulate a receiver laser lookup table, as shown in Table 2.

TABLE 2

| Receiver laser tempera- | Wavelength of the |
|---|---|
| ture monitoring point | receiver laser |
| LO Thermal Monitor_1 | LO WaveLen_1 |
| LO Thermal Monitor_2 | LO WaveLen_2 |
| LO Thermal Monitor_3 | LO WaveLen_3 |
| . . . | . . . |
| LO Thermal Monitor_i | LO WaveLen_i |
| . . . | . . . |
| LO Thermal Monitor_M | LO WaveLen_M |

It should be noted that lookup table data of the transmitter laser and the receiver laser will be different due to the differences in the lasers used. Furthermore, although only part of the data is listed here, the actual lookup table data will be more in number to ensure accuracy. As the temperature rises, the wavelength emitted by the laser will become longer. Therefore, in this embodiment, by adjusting the wavelength adjustment member of the transmitter laser or the wavelength adjustment member of the receiver laser to adjust the temperature of the transmitter laser or the receiver laser, the wavelength of the transmitter laser and the wavelength of the receiver laser can be indirectly adjusted. By establishing a one-to-one lookup table for temperature and wavelength, the wavelength required for communication can be quickly located when initially establishing communication. Furthermore, by setting the temperature monitoring points to increase in sequence, the lookup table is more convenient for searching the temperature and the corresponding wavelength.

Furthermore, the wavelength of the laser is affected by temperature, and will also be affected by the operating current. Under the same temperature, the greater the operating current, the longer the wavelength. However, the increase in operating current will be accompanied by an increase in a laser output optical power, and the increase in temperature will be accompanied by a decrease in the laser output optical power. That is, a laser wavelength is positively correlated with both the temperature and the operating current; the laser output optical power is positively correlated with the operating current and inversely correlated with the temperature. Changes in the operating current have a greater impact on the laser output optical power, and changes in the temperature have a greater impact on the laser wavelength. Changes in the laser output optical power will affect the overall performance of coherent transmission. Therefore, when initially setting the laser, it is necessary to comprehensively consider the two parameters of the laser wavelength and the laser output optical power. At the same time, the stability of the laser wavelength and the laser output optical power is maintained to improve the implementation process.

Therefore, in one embodiment, the laser wavelength and the laser output optical power are obtained for different transmitter laser temperature monitoring points and different operating currents, thereby formulating the transmitter laser lookup table.

Specifically, the wavelength adjustment member of the transmitter laser is adjusted, and optionally, the wavelength adjustment member can be TEC for controlling the temperature of the transmitter laser. M transmitter laser temperature monitoring points are set to keep the transmitter laser at a target temperature as follows: TX Thermal Monitor_1, TX Thermal Monitor_2, . . . , TX Thermal Monitor_i, . . . . TX Thermal Monitor_M, where I≤M. Optionally, the temperature values of the M transmitter laser temperature monitoring points can be obtained through a thermistor.

When the transmitter laser temperature monitoring point is set to TX Thermal Monitor_1, the operating current of the transmitter laser is controlled, and N operating currents of the transmitter laser are set as: TX Laser Current_1, TX Laser Current 2, . . . , TX Laser Current_j, . . . , TX Laser Current_N, where j≤N. Optionally, the N operating currents of the transmitter laser can be obtained from an electrical control box of the transmitter laser.

When the transmitter laser temperature monitoring point is set to TX Thermal Monitor_1 and the operating current of the transmitter laser is TX Laser Current_1, an obtained transmitting reference output optical power of the transmitter laser is TX Power_11, and an obtained transmitting reference wavelength of the transmitter laser is TX WaveLen_11; when the transmitter laser temperature monitoring point is set to TX Thermal Monitor_1 and the operating current of the transmitter laser is TX Laser Current_2, the obtained transmitting reference output optical power of the transmitter laser is TX Power_12, and the obtained transmitting reference wavelength of the transmitter laser is TX WaveLen_12. Similarly, when the transmitter laser temperature monitoring point is set to TX Thermal Monitor_1 and the operating current of the transmitter laser is TX Laser Current_N, the obtained transmitting reference output optical power of the transmitter laser is TX Power_1N, and the obtained transmitting reference wavelength of the transmitter laser is TX WaveLen_1N.

When the transmitter laser temperature monitoring point is set to TX Thermal Monitor_2 and the operating current of the transmitter laser is TX Laser Current_1, the obtained transmitting reference output optical power of the transmitter laser is TX Power_21, and the obtained transmitting reference wavelength of the transmitter laser is TX WaveLen_21; when the transmitter laser temperature monitoring point is set to TX Thermal Monitor_2 and the operating current of the transmitter laser is TX Laser Current_2, the obtained transmitting reference output optical power of the transmitter laser is TX Power_22, and the obtained transmitting reference wavelength of the transmitter laser is TX WaveLen_22. Similarly, when the transmitter laser temperature monitoring point is set to TX Thermal Monitor_2 and the operating current of the transmitter laser is TX Laser Current_N, the obtained transmitting reference output optical power of the transmitter laser is TX Power_2N, and the obtained transmitting reference wavelength of the transmitter laser is TX WaveLen_2N.

Accordingly, it can be understood that when the transmitter laser temperature monitoring point is set to TX Thermal Monitor_M and the operating current of the transmitter laser is TX Laser Current_1, the obtained transmitting reference output optical power of the transmitter laser is TX Power_M1, and the obtained transmitting reference wavelength of the transmitter laser is TX WaveLen_M1; when the transmitter laser temperature monitoring point is set to TX Thermal Monitor_M and the operating current of the transmitter laser is TX Laser Current_2, the obtained transmitting reference output optical power of the transmitter laser is TX Power_M2, and the obtained transmitting reference wavelength of the transmitter laser is TX WaveLen_M2. Accordingly, when the transmitter laser temperature monitoring point is set to TX Thermal Monitor_M and the operating current of the transmitter laser is TX Laser Current_N, the obtained transmitting reference output optical power of the transmitter laser is TX Power_MN, and the obtained transmitting reference wavelength of the transmitter laser is TX WaveLen_MN.

Therefore, the transmitting reference output optical power and transmitting reference wavelength of the transmitter laser under different transmitter laser temperature monitoring points and different transmitter laser operating currents can be scanned, and then the transmitter laser lookup table can be obtained.

In certain implementations, the abovementioned transmitter laser lookup table can be as shown in Table 3.

TABLE 3

| | TX Laser | TX Laser | TX Laser | | TX Laser | | TX Laser |
|---|---|---|---|---|---|---|---|
| | Current_1 | Current_2 | Current_3 | . . . | Current_j | . . . | Current_N |
| TX | TX | TX | TX | . . . | TX | . . . | TX |
| Thermal | Power_11 | Power_12 | Power_13 | | Power_1j | | Power_1N |
| Monitor_1 | TX | TX | TX | . . . | TX | . . . | TX |
| | WaveLen_11 | WaveLen_12 | WaveLen_13 | | WaveLen_1j | | WaveLen_1N |
| TX | TX | TX | TX | . . . | TX | . . . | TX |
| Thermal | Power_21 | Power_22 | Power_23 | | Power_2j | | Power_2N |
| Monitor_2 | TX | TX | TX | . . . | TX | . . . | TX |
| | WaveLen_21 | WaveLen_22 | WaveLen_23 | | WaveLen_2j | | WaveLen_2N |
| TX | TX | TX | TX | . . . | TX | . . . | TX |
| Thermal | Power_31 | Power_32 | Power_33 | | Power_3j | | Power_3N |
| Monitor_3 | TX | TX | TX | . . . | TX | . . . | TX |
| | WaveLen_31 | WaveLen_32 | WaveLen_33 | | WaveLen_3j | | WaveLen_3N |
| . . . | . . . | . . . | . . . | . . . | . . . | . . . | . . . |
| TX | TX | TX | TX | . . . | TX | . . . | TX |
| Thermal | Power_i1 | Power_i2 | Power_i3 | | Power_ij | | Power_iN |
| Monitor_i | TX | TX | TX | | TX | | TX |
| | WaveLen_i1 | WaveLen_i2 | WaveLen_i3 | . . . | WaveLen_3j | . . . | WaveLen_iN |
| . . . | . . . | . . . | . . . | . . . | . . . | . . . | . . . |
| TX | TX | TX | TX | . . . | TX | . . . | TX |
| Thermal | Power_M1 | Power_M2 | Power_M3 | | Power_Mj | | Power_MN |
| Monitor_M | TX | TX | TX | . . . | TX | . . . | TX |
| | WaveLen_M1 | WaveLen_M2 | WaveLen_M3 | | WaveLen_Mj | | WaveLen_MN |

Optionally, TX Thermal Monitor_1 to TX Thermal Monitor_M increase in sequence, and TX Laser Current_1 to TX Laser Current_N increase in sequence. As a result, under the same operating current of the transmitter laser, TX WaveLen_1j to TX WaveLen_Mj (j=1, 2, 3 . . . . N) increase in sequence, and TX Power_1j to TX Power_Mj (j=0, 1, 2, 3 . . . ) decrease in sequence; under the same transmitter laser temperature monitoring point, TX WaveLen_i1 to TX WaveLen_iN (i=1, 2, 3 . . . . M) increase in sequence, and TX Power_i1 to TX Power_iN (i=1, 2, 3 . . . . M) increase in sequence.

In the same way, the relationship between the parameters and wavelengths of the receiver laser can be obtained, so as to formulate a receiver laser lookup table, as shown in Table 4.

TABLE 4

| | LO Laser | LO Laser | LO Laser | | LO Laser | | LO Laser |
|---|---|---|---|---|---|---|---|
| | Current_1 | Current_2 | Current_3 | . . . | Current_j | . . . | Current_N |
| LO | LO | LO | LO | . . . | LO | . . . | LO |
| Thermal | Power_11 | Power_12 | Power_13 | | Power_1j | | Power_1N |
| Monitor_1 | LO | LO | LO | . . . | LO | . . . | LO |
| | WaveLen_11 | WaveLen_12 | WaveLen_13 | | WaveLen_1j | | WaveLen_1N |
| LO | LO | LO | LO | . . . | LO | . . . | LO |
| Thermal | Power_21 | Power_22 | Power_23 | | Power_2j | | Power_2N |
| Monitor_2 | LO | LO | LO | . . . | LO | . . . | LO |
| | WaveLen_21 | WaveLen_22 | WaveLen_23 | | WaveLen_2j | | WaveLen_2N |
| LO | LO | LO | LO | . . . | LO | . . . | LO |
| Thermal | Power_31 | Power_32 | Power_33 | | Power_3j | | Power_3N |
| Monitor_3 | LO | LO | LO | . . . | LO | . . . | LO |
| | WaveLen_31 | WaveLen_32 | WaveLen_33 | | WaveLen_3j | | WaveLen_3N |
| . . . | . . . | . . . | . . . | . . . | . . . | . . . | . . . |
| LO | LO | LO | LO | . . . | LO | . . . | LO |
| Thermal | Power_i1 | Power_i2 | Power_i3 | | Power_ij | | Power_iN |
| Monitor_i | LO | LO | LO | . . . | LO | . . . | LO |
| | WaveLen_i1 | WaveLen_i2 | WaveLen_i3 | | WaveLen_3j | | WaveLen_iN |
| . . . | . . . | . . . | . . . | . . . | . . . | . . . | . . . |
| LO | LO | LO | LO | . . . | LO | . . . | LO |
| Thermal | Power_M1 | Power_M2 | Power_M3 | | Power_Mj | | Power_MN |
| Monitor_M | LO | LO | LO | . . . | LO | . . . | LO |
| | WaveLen_M1 | WaveLen_M2 | WaveLen_M3 | | WaveLen_Mj | | WaveLen_MN |

Optionally, LO Thermal Monitor_1 to LO Thermal Monitor_M increase in sequence, and LO Laser Current_1 to LO Laser Current_N increase in sequence. Therefore, under the same receiver laser operating current, LO WaveLen_1j to LO WaveLen_Mj (j=1, 2, 3 . . . . N) increase in sequence, and LO Power_1j to LO Power_Mj (j=0, 1, 2, 3 . . . ) decrease in sequence; under the same receiver laser temperature monitoring point, LO WaveLen_i1 to LO WaveLen_iN (i=1, 2, 3 . . . . M) increase in sequence, and LO Power_i1 to LO Power_iN (i=1, 2, 3 . . . . M) increase in sequence.

It can be understood that the lookup table data of the transmitter laser and the receiver laser will be different due to the differences of the lasers used. In addition, although only part of the data is listed here, the actual lookup table data will be more in number to ensure accuracy.

In certain embodiments, the transmitter laser temperature monitoring point and the receiver laser temperature monitoring point can be set to the same temperature monitoring point; the operating current of the transmitter laser and the operating current of the receiver laser can be set to the same operating current.

Since the wavelength of the laser is affected by both the temperature and the operating current, a lookup table of temperature, operating current and wavelength is formulated for both the transmitter laser and the receiver laser. The change of operating current will affect the output optical power of the light source, and the change of the output optical power of the light source will affect the overall performance of coherent transmission. Therefore, when initially setting the transmitter laser and the receiver laser, it is necessary to comprehensively consider the two parameters of the laser wavelength and the laser output optical power. The temperature of the transmitter laser or the receiver laser is adjusted by adjusting a temperature controller of the transmitter laser and a temperature controller of the receiver laser; the operating current of the transmitter laser and the operating current of the receiver laser are adjusted by the electrical control box of the transmitter laser and an electrical control box of the receiver laser. The abovementioned method can indirectly adjust the wavelength of the transmitter, the wavelength of the local oscillator light, the output optical power of the transmitter and the output optical power of the local oscillator light. By establishing a corresponding lookup table of temperature, operating current, wavelength and output optical power, the wavelength required for communication can be quickly located when the communication is initially established. Furthermore, by setting the temperature monitoring points to increase sequentially and the operating current to increase sequentially, the lookup table can be made more convenient for searching the temperature and the operating current and the corresponding wavelength and output optical power.
S306 includes reading the lookup table to obtain the relationship between the parameters and the wavelengths of the transmitter laser and the receiver laser through the lookup table.

In order to quickly adjust the wavelength of the transmitter laser and the receiver laser to a set value, in one embodiment, the required temperature and/or current is obtained by reading the pre-calibrated transmitter laser lookup table and the receiver laser lookup table in the memory, such that the transmitter laser and the local oscillator light source can quickly reach the required temperature and/or current, and achieve the output of the required wavelength.
S307 includes adjusting parameters of the receiver laser so that the receiver laser emits local oscillator light of a preset wavelength.

In one embodiment, according to the relationship between the parameters and the wavelength, the parameters of the receiver laser are adjusted so that the receiver laser emits the local oscillator light of the preset wavelength.
S308 includes adjusting parameters of the transmitter laser so that the transmitter laser emits signal light of a preset wavelength.

In one embodiment, according to the relationship between the parameters and the wavelength, the parameters of the transmitter laser are adjusted so that the transmitter laser outputs the signal light of the preset wavelength.

Specifically, when the preset wavelength of the transmitter laser is WaveLen_n, the preset local oscillator light wavelength of the receiver laser is also WaveLen_n. Then, the wavelengths of the two transmitter lasers TX WaveLen_i and TX WaveLen_(i+1) that satisfy formula (1) can be found in the transmitter laser lookup table; similarly, the wavelengths of the two receiver lasers LO WaveLen_i and LO WaveLen_(i+1) that satisfy formula (2) can also be found in the receiver laser lookup table:

TX WaveLen_i<WaveLen_n≤TX WaveLen_(i+1), in which i=1, 2, 3, . . . , M (1)

LO WaveLen_i<WaveLen_n≤LO WaveLen_(i+1), in which i=1, 2, 3, . . . , M (2)

Therefore, a fitting algorithm, such as a linear interpolation method, can be used to obtain a preset transmitter laser temperature monitoring point and a preset receiver laser temperature monitoring point. The temperature of the transmitter laser is set to the transmitter laser temperature monitoring point through the wavelength adjustment member of the transmitter laser, and the temperature of the receiver laser is set to the receiver laser temperature monitoring point through the wavelength adjustment member of the receiver laser, such that the transmitter laser emits the signal light of the preset wavelength, and the receiver laser emits the local oscillator light of the preset wavelength.

Specifically, in one embodiment, the preset wavelength of the transmitter laser is WaveLen_n, and the preset wavelength of the receiver laser is also WaveLen_n. When looking up WaveLen_n in the transmitter laser lookup table, i=2 is obtained, that is, for the transmitter laser, the following can be obtained:

TX WaveLen_2<WaveLen_n≤TX WaveLen_3;
optionally, the transmitter laser lookup table is a linear table; therefore, for the transmitter laser, the preset transmitter laser temperature monitoring point satisfies the following:

TX Thermal Monitor_2<TX Thermal Monitor n≤TX Thermal Monitor_3;
when looking up WaveLen_n in the receiver laser lookup table, i=4 is obtained, that is, for the receiver laser, the following can be obtained:

LO WaveLen_4<WaveLen_n≤LO WaveLen_5;
optionally, the receiver laser lookup table is a linear table; therefore, for the receiver laser, the preset receiver laser temperature monitoring point satisfies the following:

LO Thermal Monitor_4<LO Thermal Monitor n≤LO Thermal Monitor_5;
furthermore, the specific value of the preset transmitter laser temperature monitoring point and the specific value of the preset receiver laser temperature monitoring point can be obtained by linear interpolation.

For the transmitter laser, the specific value of an initial transmitter laser temperature monitoring point can be obtained by formula (3) of:

$$TX Thermal Monitor\_n = \frac{TX Thermal Monitor\_ 3 - TX Thermal Monitor\_ 2}{TX WaveLen\_ 3 - TX WaveLen\_ 2} \times ( WaveLen\_n - TX WaveLen\_ 2 ) + TX Thermal Monitor\_ 2. \qquad ( 3 )$$

For the receiver laser, the specific value of the preset receiver laser temperature monitoring point can be obtained by formula (4) of:

$$LO Thermal Monitor\_n = \frac{LO Thermal Monitor\_ 5 - LO Thermal Monitor\_ 4}{LO WaveLen\_ 5 - LO WaveLen\_ 4} \times ( WaveLen\_n - LO WaveLen\_ 4 ) + LO Thermal Monitor\_ 4 . \qquad ( 4 )$$

Therefore, the temperature of the transmitter laser is set to TX Thermal Monitor_n through the wavelength adjustment member of the transmitter laser, and the temperature of the local oscillator light source is set to LO Thermal Monitor_n through the wavelength adjustment member of the receiver laser, such that the transmitter laser emits a preset signal light wavelength WaveLen_n, and the receiver laser emits a preset local oscillator light wavelength WaveLen_n.

It can be understood that the preset wavelengths of the uplink transmitter laser and the downlink receiver laser are both realized by looking up the lookup table, and the uplink transmitter laser keeps the temperature monitoring point and the driving current unchanged for a long time, so as to keep the operating conditions basically unchanged and the signal light wavelength as stable as possible.

As the operating time and ambient temperature change, the wavelength drift of the uplink transmitter laser and the downlink receiver laser is inevitable, and the drift amounts are inconsistent. Therefore, after the signal light wavelength emitted by the uplink transmitter laser is received by the downlink receiving end, the signal light wavelength that is received will be inconsistent with the wavelength of the local oscillator light emitted by the downlink receiver laser. Therefore, it is necessary to further adjust the wavelength of the downlink local oscillator light in real time to keep the wavelength of the local oscillator light consistent with the wavelength of the received signal light.

In one embodiment, S330 of adjusting the wavelength of the local oscillator light emitted by the receiver laser according to the wavelength information of the external signal light so that the wavelength of the local oscillator light emitted by the receiver laser tends to be consistent with the wavelength of the external signal light that is received, includes:
S3302, which includes comparing the wavelength of the external signal light with the wavelength of the local oscillator light emitted by the receiver laser.
S3304 includes, when the wavelength of the local oscillator light emitted by the receiving end is greater than the wavelength of the external signal light, reducing a temperature of the receiver laser.
S3306 includes, when the wavelength of the local oscillator light emitted by the receiving end is smaller than the wavelength of the external signal light, increasing the temperature of the receiver laser.

Specifically, the receiving end processes a received external signal light to obtain a wavelength difference λ_{RX}-λ_{LO} between the received external signal light wavelength λ_{RX} and the wavelength of the local oscillator light λ_{LO} of the receiver laser. The wavelength difference is collected in real time over a long period of time. Optionally, the wavelength difference is collected in real time over a long period of time by a microcontroller unit (MCU).

When the wavelength difference λ_{RX}-λ_{LO} is less than 0, that is, the wavelength of the local oscillator light is greater than the wavelength of the received external signal light, the MCU controls the TEC at the receiving end to lower the temperature, thereby reducing the operating temperature of the receiver laser, such that the wavelength of the local oscillator light λ_{LO} is reduced to the same as the wavelength λ_{RX} of the received external signal light.

When the wavelength difference λ_{RX}-λ_{LO} is greater than 0, that is, the wavelength of the local oscillator light is smaller than the wavelength of the received external signal light, the MCU controls the TEC at the receiving end to increase the temperature, thereby increasing the operating temperature of the receiver laser, such that the wavelength of the local oscillator light λ_{LO} increases to the same as the wavelength λ_{RX} that is received.

In this embodiment, by adjusting the wavelength of the local oscillator light in real time, a long-term consistency can be maintained between the wavelength λ_{RX} of the external signal light received by the receiving end and a transmitted wavelength of the uplink transmitter laser under various operating conditions, thereby achieving wavelength locking control.

In one embodiment, receiving the external signal light includes: receiving the external signal light that is modulated by coherent modulation.

In another embodiment, as shown in FIG. 4, an optical communication method is provided, which includes the following steps of:
S305, which includes formulating the relationship between parameters and wavelengths of the transmitter laser and the receiver laser into a corresponding lookup table, and store the lookup table in a memory.
S306 includes reading the lookup table to obtain the relationship between the parameters and the wavelengths of the transmitter laser and the receiver laser through looking up the table.
S307 includes adjusting parameters of the receiver laser so that the receiver laser emits local oscillator light of a preset wavelength.
S308 includes adjusting parameters of the transmitter laser so that the transmitter laser emits signal light of a preset wavelength.
S310 includes receiving external signal light that is modulated by coherent modulation.
S320 includes obtaining wavelength information of the external signal light and wavelength information of local oscillator light of the receiver laser.
S3302 includes comparing the wavelength of the external signal light with the wavelength of the local oscillator light emitted by the receiver laser.
S3304 includes, when the wavelength of the local oscillator light emitted by the receiving end is greater than the wavelength of the external signal light, reducing a temperature of the receiver laser.
S3306 includes, when the wavelength of the local oscillator light emitted by the receiving end is smaller than the wavelength of the external signal light, increasing the temperature of the receiver laser.
S340 includes mixing the external signal light with the wavelength of the local oscillator light emitted by the receiver laser, and then demodulating the wavelength to obtain a demodulated signal.

In this embodiment, the transmitter laser and the receiver laser directly adopt DFB laser light source, which reduces the requirements for the laser light source, and even the adoption of a tunable laser having an external cavity is not necessary, such that the overall volume is small, the integration is high, and the cost is low. Since the transmitter laser and the receiver laser use two lasers, the temperature change of each of the lasers will affect the output wavelength of the laser. Therefore, by establishing a one-to-one correspondence between the temperature and the wavelength, the wavelength required for communication can be quickly located according to the transmitter laser lookup table and the receiver laser lookup table when the communication is initially established. Furthermore, by adjusting the transmitter laser temperature monitoring point and the receiver laser temperature monitoring point, the transmitter laser and the receiver laser are controlled to emit the preset signal light wavelength and the preset local oscillator light wavelength that are the same wavelength, so as to quickly establish communication. Moreover, in the process of communication, the signal light wavelength that is received is compared with the wavelength of the local oscillator light in real time, and the wavelength of the local oscillator light is adjusted to be consistent with the signal light wavelength that is received, so as to ensure automatic adjustment at the receiving end for the wavelength of the local oscillator light of the receiving end. Therefore, the wavelength of the local oscillator light is consistent with the signal light wavelength that is received, such that the subsequent signal extraction is more accurate.

It should be understood that, although the various steps in the flowcharts involved in the above-mentioned embodiments are displayed in sequence according to the indication of the arrows, these steps are not necessarily executed in sequence according to the order indicated by the arrows. Unless there is a clear explanation in the detailed description, the execution of these steps is not strictly limited to an order, and these steps can be executed in other orders. Furthermore, at least a part of the steps in the flowcharts involved in the above-mentioned embodiments can include multiple steps or multiple stages, and these steps or stages are not necessarily executed at the same time, but can be executed at different times, and the order of execution of these steps or stages is not necessarily carried out in sequence, but can be executed in turn or alternately with other steps or at least a part of the steps or stages in other steps.

The technical features of the abovementioned embodiments may be combined arbitrarily. To describe concisely, not all possible combinations of the technical features in the abovementioned embodiments are described. However, as long as there is no contradiction in the combination of these technical features, they should be considered to be within the scope of the present specification.

The embodiments above only express certain manner of implementing the present invention, and the descriptions thereof are relatively specific and detailed, but they cannot be understood as limiting the scope of the present invention. It should be noted that, for a skilled person in the art, several modifications and improvements can be made without departing from the concept of the present invention, and these are all within the scope of the present invention. Therefore, the protection scope of the present invention shall be referred to the attached claims.

1. An optical communication module, characterized in that, the module comprises:
a housing;
a transmitter laser located in the housing for emitting a transmitting laser;
a receiver laser located in the housing for emitting local oscillator light, wherein the local oscillator light is mixed with an external optical signal to obtain a mixed frequency signal;
a digital signal processor located in the housing for processing a digital signal;
a coherent modulator located in the housing, connected to the digital signal processor, and used to load the digital signal transmitted from the digital signal processor onto the transmitting laser emitted by the transmitter laser to form signal light;
a coherent receiver, located in the housing, connected to the digital signal processor and the receiver laser, and used to demodulate and transmit the mixed frequency signal to the digital signal processor, wherein the digital signal processor is further used for processing and outputting the mixed frequency signal that is demodulated;
a microprocessor, located in the housing and used to control the digital signal processor, a wavelength control assembly, the transmitter laser, and the receiver laser;
the wavelength control assembly located in the housing and used to control a wavelength of the transmitting laser and a wavelength of the local oscillator light.

2. The module according to claim 1, characterized in that, the transmitter laser includes a DFB laser device or a silicon photonic integrated external cavity tunable laser device.

3. The module according to claim 1, characterized in that, the receiver laser includes a DFB laser device or a silicon photonic integrated external cavity tunable laser device.

4. The module according to claim 1, characterized in that, the coherent modulator and the coherent receiver are integrated silicon photonic chips.

5. The module according to claim 1, characterized in that, the wavelength control assembly includes a thermistor and a wavelength adjustment member; wherein the microprocessor monitors a temperature of the transmitter laser and the receiver laser through the thermistor, and adjusts the temperature of the transmitter laser and the receiver laser through the wavelength adjustment member.

6. The module according to claim 5, characterized in that, the wavelength adjustment member includes a TEC.

7. The module according to claim 6, characterized in that, the transmitter laser and the receiver laser are disposed on different ones of the TEC.

8. The module according to claim 1, characterized in that, the module further comprises:
a mixer forming an integrated silicon photonic chip with the coherent modulator and the coherent receiver; wherein the mixer is used to mix the local oscillator light emitted by the receiver laser with the external optical signal to obtain the mixed frequency signal.

9. The module according to claim 8, characterized in that, the transmitter laser and/or the receiver laser is a silicon photonic integrated external cavity tunable laser device, and the silicon photonic integrated external cavity tunable laser device, the mixer, the coherent modulator, and the coherent receiver form the integrated silicon photonics chip.

10. An optical communication method, characterized in that, the method comprises:
receiving external signal light;
obtaining wavelength information of the external signal light and wavelength information of local oscillator light of the receiver laser;
adjusting a wavelength of the local oscillator light emitted by the receiver laser according to the wavelength information of the external signal light, so that the wavelength of the local oscillator light emitted by the receiver laser tends to be consistent with a wavelength of the external signal light that is received;
mixing the wavelength of the external signal light with the wavelength of the local oscillator light emitted by the receiver laser and demodulating the wavelength to obtain a demodulated signal.

11. The method according to claim 10, characterized in that, before receiving the external signal light, the method further comprises:
adjusting parameters of a transmitter laser so that the transmitter laser emits signal light of a preset wavelength.

12. The method according to claim 11, characterized in that, before adjusting the parameters of the transmitter laser so that the transmitter laser emits the signal light of the preset wavelength, the method further comprises:
adjusting parameters of the receiver laser so that the receiver laser emits local oscillator light of a preset wavelength.

13. The method according to claim 12, characterized in that, before adjusting the parameters of the receiver laser so that the receiver laser emits the local oscillator light of the preset wavelength, the method further comprises:
formulating a relationship between parameters and wavelengths of the transmitter laser and the receiver laser into a corresponding lookup table, and storing the lookup table in a memory;
reading the lookup table to obtain the relationship between the parameters and the wavelengths of the transmitter laser and the receiver laser through the lookup table.

14. The method according to claim 10, characterized in that, the process of adjusting the wavelength of the local oscillator light emitted by the receiver laser according to the wavelength information of the external signal light so that the wavelength emitted by the receiver laser tends to be consistent with the wavelength of the received external signal light includes:
comparing the wavelength of the external signal light with the wavelength of the local oscillator light emitted by the receiver laser;
when the wavelength of the local oscillator light emitted by a receiving end is greater than the wavelength of the external signal light, reducing a temperature of the receiver laser;
when the wavelength of the local oscillator light emitted by the receiving end is smaller than the wavelength of the external signal light, increasing the temperature of the receiver laser.

15. The method according to claim 10, characterized in that, the process of receiving the external signal light includes:
receiving the external signal light that is modulated by coherent modulation.
